(19) United States
(12) Patent Application Publication
(10) Pub. No.: US 2013/0118706 A1
(43) Pub. Date: May 16, 2013

(54) Inspection Method And Device With Heat Exchangers

(71) Applicants: Joseph A. Kareh, Westwood, MA (US); Theodore D. Ciolkosz, Plymouth, MA (US); Ziad El-Massih, Wrentham, MA (US)

(72) Inventors: Joseph A. Kareh, Westwood, MA (US); Theodore D. Ciolkosz, Plymouth, MA (US); Ziad El-Massih, Wrentham, MA (US)

(73) Assignee: WATERS TECHNOLOGIES CORPORATION, Milford, MA (US)

(21) Appl. No.: 13/638,977

(22) PCT Filed: Apr. 6, 2011
(86) PCT No.: PCT/US11/31352

§ 371 Date: Dec. 10, 2012

Related U.S. Application Data
(60) Provisional application No. 61/322,319, filed on Apr. 9, 2010.

(51) Int. Cl. G01N 25/18

(52) U.S. Cl. CPC G01N 25/18
USPC 165/11.1; 374/5

(57) ABSTRACT

An inspection device and method, the device comprising a thermoelectric module (3) with first and second conducting parts (31, 32) and a control unit (4) electrically connected to the thermoelectric module for selectively applying an electric potential to the thermoelectric module to create a temperature difference between the first and second conducting parts. The control unit comprises measuring means configured to measure transiently, in use, a voltage potential across the thermoelectric module. The control unit includes memory means for recording a measured voltage profile and further comprises comparing means (41) for comparing the measured profile with a predetermined voltage profile stored in the memory means.

### CROSS-REFERENCE TO RELATED APPLICATIONS

This application claims priority to U.S. Provisional Application No. 61/322,319, filed on Apr. 9, 2010, the entire contents of which are incorporated herein by reference.

### FIELD OF THE INVENTION

This invention relates generally to inspection devices and more specifically to such devices for detecting defects in assemblies. More specifically, although not exclusively, this invention relates to inspection devices for inspecting and/or detecting defects in heat exchange apparatus.

### BACKGROUND

Heat exchangers are used in a variety of applications and are often integrated within the construction of certain apparatus or systems. One such system is a chromatography system.

Chromatography is the science of separating compounds held in solution. The compounds are separated by flowing the solution through a stationary phase. Compounds held in the solution exhibit different affinities for the stationary phase and separate from each other. Common stationary phases are solids such as a packed bed of particles, beads, fibres, and solid structures known in the art as “porous monoliths”. These solid stationary phases will be referred to herein as solid phase separation media, or simply, separation media.

The time that a compound takes to pass through the compound is dependent upon the affinity of that compound to the stationary phase. This is known as the elution time. The elution time of a compound is an important indicator of the identity of the compound. The elution time of a compound is also dependent upon the temperature at which the separation is performed.

Chromatography systems are held at a constant temperature by heat exchangers that regulate the temperature of the apparatus. One common fault in chromatography apparatus that results in poor performance is the failure of the heat exchangers. However, the performance of such heat exchangers is difficult to measure in the field and it generally requires the apparatus to be disassembled.

### SUMMARY

A first non-exclusive object is to provide an alternative and/or improved method and/or device for inspecting a heat exchanger or other thermally conductive apparatus. It is a more specific non-exclusive object to provide such a method and/or device that overcomes or at least mitigates the issues associated with known inspection methods and/or devices.

Accordingly, one aspect of some embodiments of the invention provides a method of inspecting a thermally conductive apparatus such as a heat exchanger. The method comprises the steps of:
a) placing a first conducting part of a thermoelectric module in thermal contact with the apparatus;
b) placing a second conducting part of the thermoelectric module in thermal contact with a thermal mass, for example a heat sink;
c) applying a voltage to the thermoelectric module to create a temperature differential between the first and second conducting parts, thereby heating one of the apparatus and the thermal mass and cooling the other one of the apparatus and the thermal mass;
d) ceasing to apply the voltage to the thermoelectric module;
e) measuring the profile of the voltage potential across the thermoelectric module over time; and
f) comparing the measured profile with a predetermined or baseline voltage profile to identify a difference therebetween that could indicate a defect in the apparatus.

The method may comprise the use of a control means or unit, for example the application of the voltage may be controlled by the control means or unit. The method may further comprise recording and/or storing the measured profile, for example in a memory unit, e.g. after or upon or starting upon the voltage removal or ceasing step and/or until the measured voltage reaches or approaches zero. The predetermined or baseline voltage profile may be recorded or stored in the memory unit. The comparison step may be carried out using a display unit, e.g. for displaying a combined or an overlaid graphical representation of the voltage profiles. Additionally or alternatively, the comparison step may be carried out automatically, for example using the control means or unit, e.g. to identify the difference. The difference identified is preferably configured to be significant or a difference exceeding a predetermined threshold or a difference falling outside a predetermined or target range.

A second aspect of some embodiments of the invention provides an inspection device, e.g. for carrying out a method according to the first aspect of the invention, the device comprising a thermoelectric module with first and second conducting parts and a control means or unit electrically connected to the thermoelectric module for selectively applying an electric potential to the thermoelectric module to create a temperature difference between the first and second conducting parts, wherein the control means or unit comprises measuring means or unit configured to measure, e.g. measure transiently, in use, a voltage potential across the thermoelectric module.

The control means or unit preferably includes a memory unit, e.g. for recording and/or storing a measured profile of the voltage. The control means or unit may further include one or more voltage profiles stored in the memory unit for comparison with the measured profile. More preferably, the control means or unit comprises comparing means, such as a processor or other computing device, for comparing the measured profile with a predetermined or baseline voltage profile, e.g. one or more stored voltage profiles. The comparing means may comprise a display unit, e.g. for displaying a combined or an overlaid graphical representation of the voltage profiles. Additionally or alternatively, the comparing means may comprise automatic comparing means, for example a process and/or other component, for example configured to identify a difference therebetween, e.g. a significant difference or a difference exceeding a predetermined threshold or a difference falling outside a predetermined or target range.

The device may further comprise an electric power source, e.g. operatively coupled to the control means or unit and/or to the thermoelectric module. The device or control means or unit or measuring means preferably comprises a voltage measuring module or unit and/or it may be configured to measure and/or record and/or store a voltage potential across the thermoelectric module after or upon or starting upon voltage removal or ceasing step and/or until the measured voltage reaches or approaches zero.

The method is preferably carried out using the device according to the second aspect of the invention.

A third aspect provides a heat exchanger comprising an inspection device according to the second aspect.

### DRAWINGS

Some embodiments of the invention will now be described by way of example only with reference to the accompanying drawings in which:

FIG. 1 is a schematic view of an inspection device according to one embodiment of the invention shown mounted to a heat exchanger; and

FIG. 2 is a graphical representation of the voltage potential across the thermoelectric module of the inspection device over time.

### DESCRIPTION

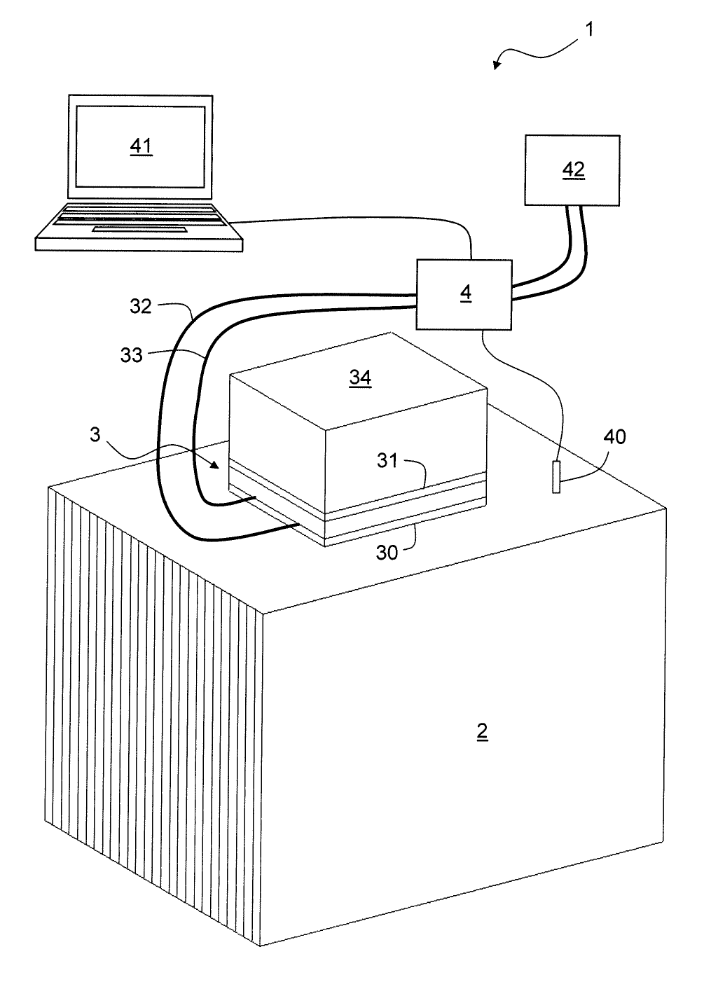

Referring to FIG. 1, there is shown an inspection device 1 mounted to a heat exchanger 2 for testing the proper functioning of the heat exchanger 2. The heat exchanger 2 is incorporated within a chromatography system (not shown) in this embodiment.

The inspection device 1 includes a thermoelectric module 3 with hot and cold conducting parts 30, 31 and a pair of electrical cables or wires 32, 33 electrically connecting the thermoelectric module 3 to a control unit 4. The inspection device 1 also includes a thermal mass 34 in thermal contact with the cold conducting part 31, while the hot conducting part 30 of the inspection device 1 is in thermal contact with the heat exchanger 2.

The control unit 4 includes a temperature probe 40 in thermal contact with the heat exchanger 2 for measuring the temperature thereof. The control unit 4 is electrically connected to and controlled or programmable by a laptop computer 41 and is also electrically connected to a power source 42, which power source 42 supplies electrical power to the thermoelectric module 3 via the control unit 4.

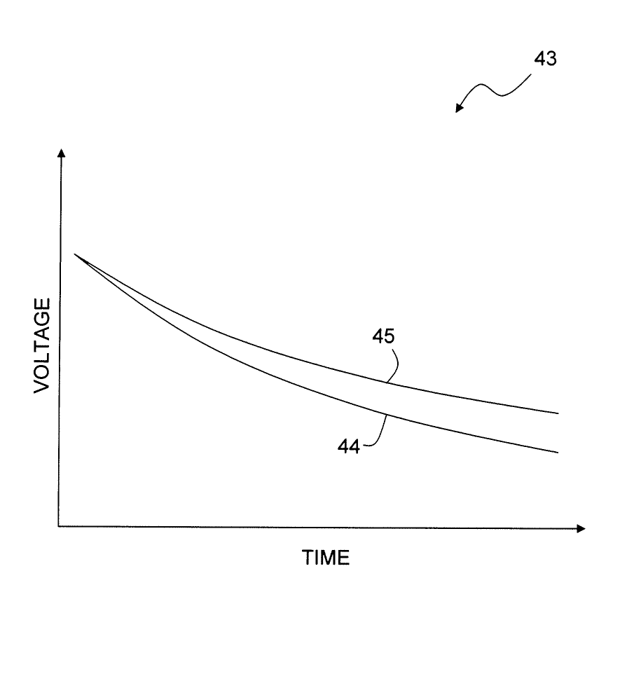

The control unit 4 is configured or programmed to selectively apply power to the thermoelectric module 3 to create a temperature difference between the hot and cold conducting parts 30, 31. The control unit 4 also includes a voltmeter (not shown) configured to measure transiently a voltage potential across the thermoelectric module 3 and the measured values and/or profile are recorded or stored in the memory (not shown) of the laptop 41. The memory (not shown) of the laptop 41 also includes a baseline voltage profile 45 stored therein for comparison with the measured profile 44 (see FIG. 2). The baseline voltage profile represents a voltage profile measured during an earlier inspection of the heat exchanger 2 when it was known to be functioning properly (see FIG. 2).

In use, inspection of the heat exchanger 2 may be done without the need to remove it from the chromatography system (not shown). In order to inspect the heat exchanger 2, the control unit 4 first applies a voltage to the thermoelectric module 3 to create a predetermined temperature differential between the heat exchanger 2 and thermal mass 34 via the hot and cold conducting parts 30, 31. When the temperature of the heat exchanger 2 measured by the temperature probe 40 reaches a predetermined temperature, the power supplied by the control unit 4 to the thermoelectric module is stopped. The profile of the measured voltage potential across the thermoelectric module over time is recorded in the memory (not shown) of the laptop 41 and displayed graphically 43 on the screen of the laptop 41.

The graphic display 43, shown more clearly in FIG. 2, includes a temperature profile 44 measured over time overlaid with a baseline voltage profile 45. It will be appreciated that the measured temperature profile 44 deviates significantly from the baseline profile 45, indicating that there is a defect in the heat exchanger 2. The laptop 41 may include a means of comparing the profiles 44, 45 automatically and highlighting any deviation or difference of a predetermined value, indicating the presence of a defect.

It will be appreciated by those skilled in the art that several variations are envisaged without departing from the scope of the invention. For example, the inspection device 1 need not be used with heat exchangers 2 incorporated in chromatography systems (not shown). The device 1 is useful for inspecting a heat exchanger 2 or any other type of thermally conductive apparatus, which may or may not be incorporated within any other type of device, machine or system.

It will also be appreciated by those skilled in the art that any number of combinations of the aforementioned features and/or those shown in the appended drawings provide clear advantages over the prior art and are therefore within the scope of the invention described herein.

1. A method of inspecting a thermally conductive apparatus, the method comprising the steps of:
a) placing a first conducting part of a thermoelectric module in thermal contact with the apparatus;
b) placing a second conducting part of the thermoelectric module in thermal contact with a thermal mass;
c) applying a voltage to the thermoelectric module to create a temperature differential between the first and second conducting parts, thereby heating one of the apparatus and the thermal mass and cooling the other one of the apparatus and the thermal mass;
d) ceasing to apply the voltage to the thermoelectric module;
e) measuring the profile of the voltage potential across the thermoelectric module over time; and
f)comparing the measured profile with a predetermined voltage profile to identify any difference therebetween that could indicate a defect in the apparatus.

2. Method according to claim 1, wherein the thermally conducting apparatus comprises a heat exchanger.

3. An inspection device for carrying out a method according to claim 1 or claim 2, the device comprising a thermoelectric module with first and second conducting parts and a control unit electrically connected to the thermoelectric module for selectively applying an electric potential to the thermoelectric module to create a temperature difference between the first and second conducting parts, wherein the control unit comprises measuring means configured to measure transiently, in use, a voltage potential across the thermoelectric module.

4. Device according to claim 3, wherein the control unit includes memory means for recording a measured voltage profile.

5. Device according to claim 4, wherein the control unit further comprises comparing means for comparing the measured profile with a predetermined voltage profile stored in the memory means.

6. Device according to claim 5, wherein the comparing means comprises a display means for displaying a combined or an overlaid graphical representation of the voltage profiles.

7. Device according to claim 5 or claim 6, wherein the comparing means comprises automatic comparing means configured to identify a difference between the measured and stored profiles falling outside a predetermined range indicating a defect in the apparatus.

8. Device according to any one of claims 3 to 7, wherein the device comprises a heat exchanger inspection device.

9. A heat exchange assembly comprising an inspection device according to any one of claims 3 to 8.

10. A method according to claim 1 or claim 2 carried out using an inspection device according to any one of claims 3 to 9.

11. A method of inspecting a thermally conductive apparatus substantially as described herein and/or as shown in the accompanying drawings.

12. An inspection device substantially as described herein and/or as shown in the accompanying drawings.
